(19) United States
(12) Patent Application Publication
(10) Pub. No.: US 2023/0264674 A1
(43) Pub. Date: Aug. 24, 2023

(54) PASSENGER COMPARTMENT MAPPING AND CONTROL

(71) Applicant: Panasonic Automotive Systems Company of America, Division of Panasonic Corporation of North America, PEACHTREE CITY, GA (US)

(72) Inventor: NICHOLAS BRIAN HANSEN, FAYETTEVILLE, GA (US)

(21) Appl. No.: 18/110,712

(22) Filed: Feb. 16, 2023

Related U.S. Application Data
(60) Provisional application No. 63/313,449, filed on Feb. 24, 2022.

(51) Int. Cl. B60W 10/30

(52) U.S. Cl. CPC B60W 10/30; B60W 2050/0082

(57) ABSTRACT

Examples of the disclosure relate to example devices and methods for generating a map of a vehicle’s passenger compartment and controlling features of the vehicle based on the map. An example vehicle with a passenger compartment mapping system includes one or more sensors to capture sensor data, which includes depth data for a passenger compartment of the vehicle. The system also includes one or more processors to generate a passenger compartment map from the sensor data, and control one or more subsystems of the vehicle based on the passenger compartment map.

### CROSS-REFERENCE TO RELATED APPLICATIONS

This application claims the benefit of U.S. Provisional Application No. 63/313,449, filed on Feb. 24, 2022, which the disclosure of which is hereby incorporated by reference in its entirety for all purposes.

### FIELD OF THE INVENTION

The present disclosure generally relates to a method, system, and device for mapping the passenger compartment of a vehicle and controlling subsystems of the vehicle based on the map.

### BACKGROUND

This section is intended to introduce the reader to various aspects of art, which may be related to various aspects of the present disclosure, which are described and/or claimed below. This discussion is believed to be helpful in providing the reader with background information to facilitate a better understanding of the various aspects of the present disclosure. Accordingly, it can be understood that these statements are to be read in this light, and not as admissions of prior art.

Many modern vehicle’s come equipped with a wide variety of subsystems designed to provide information, entertainment, comfort, and safety to passengers. However, the information available to these systems regarding passenger occupancy is generally limited. For example, most vehicles are equipped with airbags designed to keep passengers safe in the event of a crash. The airbag deployment system can determine whether a seat is occupied and the weight of the occupant using weight sensors coupled to the seats.

### SUMMARY

The present disclosure generally relates to techniques for generating a map of a vehicle’s passenger compartment and controlling features of the vehicle based on the map. An example vehicle with a passenger compartment mapping system includes one or more sensors to capture sensor data, which includes depth data for a passenger compartment of the vehicle. The system also includes one or more processors to generate a passenger compartment map from the sensor data, and control one or more subsystems of the vehicle based on the passenger compartment map.

An example method in accordance with embodiments includes capturing sensor data from one or more sensors disposed in a vehicle, wherein the sensor data includes depth data for a passenger compartment of the vehicle. The method also includes generating a passenger compartment map from the sensor data, wherein the passenger compartment map includes the depth data, and detected passenger positions and orientations. The method further includes controlling one or more subsystems of the vehicle based on the passenger compartment map.

An example system for mapping a passenger compartment mapping of a vehicle in accordance with embodiments includes one or more sensors to capture sensor data including depth data for a passenger compartment of the vehicle. The system also includes one or more processors to generate a passenger compartment map from the sensor data. The processor are to also control one or more subsystems of the vehicle based on the passenger compartment map.

### BRIEF DESCRIPTION OF THE DRAWINGS

The above-mentioned and other features and advantages of the present disclosure, and the manner of attaining them, may become apparent and be better understood by reference to the following description of one example of the disclosure in conjunction with the accompanying drawings, where:

FIG. 1 is an example of a vehicle configured with a passenger compartment mapping system in accordance with embodiments;

FIG. 2 is a block diagram of a system configured for passenger compartment mapping in accordance with embodiments; and

FIG. 3 is a process flow diagram summarizing an example method for controlling a vehicle based on a mapping of the passenger compartment in accordance with embodiments.

Correlating reference characters indicate correlating parts throughout the several views. The exemplifications set out herein illustrate examples of the disclosure, in one form, and such exemplifications are not to be construed as limiting in any manner the scope of the disclosure.

### DETAILED DESCRIPTION OF EXAMPLES

One or more specific examples of the present disclosure are described below. In an effort to provide a concise description of these examples, not all features of an actual implementation are described in the specification. It can be appreciated that in the development of any such actual implementation, as in any engineering or design project, numerous implementation-specific decisions may be made to achieve the developers’ specific goals, such as compliance with system-related and business-related constraints, which may vary from one implementation to another. Moreover, it can be appreciated that such a development effort might be complex and time consuming, and is a routine undertaking of design, fabrication, and manufacture for those of ordinary skill having the benefit of this disclosure.

The present disclosure describes techniques for mapping the interior of the passenger compartment of a vehicle, and using the map to control features of the vehicle. The mapping can be used to establish information about occupant presence, position, size and activity in order to allow for individualized responses from vehicle systems such as infotainment, occupant safety, and occupant comfort. Currently little information is available to vehicles systems about the presence, position, size, and activity of occupants. Consequently, vehicle systems such as infotainment, occupant safety, and occupant comfort are more or less generic. Given more detailed information about occupant presence, position, size and activity, a vehicle could provide a more customized, potentially safer and potentially more comfortable user experience.

In some embodiments, the system will include two or more sensors to create a complete, or nearly complete, map of the vehicle’s passenger compartment. A single sensor array could be used to partially map the interior of a vehicle, but due to the presence of opaque objects such as seats and consoles, only a partial picture of all of the occupants in a vehicle with two or more rows would be achievable. Adding additional sensors allows for the obscured areas to be imaged and mapped. A system of two sensors would allow for reasonably detailed mapping of the driver, front passenger, and a rear row of seats. Additional sensors could be employed if there are additional rows of seats or if additional detail is desired in certain areas.

Having a map of the vehicle’s passenger compartment enables a wide variety of useful features. For example, airbag deployment systems generally rely on seat pressure sensors to provide information about the presence of passengers within a vehicle. However, the map generated in accordance with the present techniques can provide more detailed information about occupant presence, position, size, and activity compared to seat pressure sensors. This more detailed passenger information can be used to provide more sophisticated decision making algorithms to determine whether to activate or deactivate the airbags of particular passenger areas and could also be used to adjust to deployment speeds.

Another potential use of the system would be a hands free and child friendly control scheme for a rear seat entertainment system. Many parents have experienced a child in a rear seat becoming upset that they are not being sufficiently entertained, but due to responsibilities associated with operating the vehicle, are unable to assist them. With the present system, a child could use hand gestures to manipulate the rear seat entertainment controls or to play a game.

A more reliable rear seat presence warning system could also be implemented to reduce the likelihood of unintentionally leaving a child in a vehicle. This system would likely benefit from the use of an additional a forward-facing sensor located behind the rear seat to detect a child in a rear facing child safety seat.

The same system could also, with the help of machine learning, be used to evaluate the restraint condition of the rear seat occupants to provide information to the driver about potentially unsafe restraint usage. Other applications of the system are also possible.

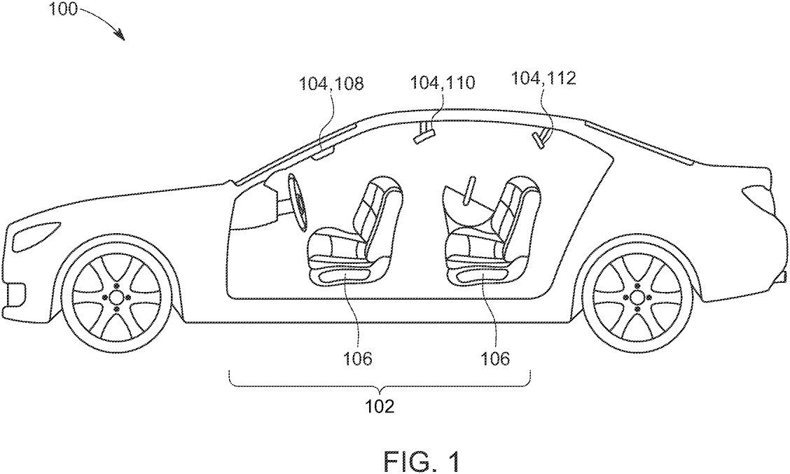

FIG. 1 is an example of a vehicle configured with a passenger compartment mapping system in accordance with embodiments. Embodiments of the present techniques may be described in the context of a vehicle 100 such as a car, truck, Sport Utility Vehicle (SUV), minivan, and the like. Although, FIG. 1 shows a vehicle with two rows of seats, it will be appreciated that a system in accordance with embodiments may be deployed in a vehicle that includes a third row of seats, and a cargo compartment.

As shown in FIG. 1, the passenger compartment 102 of the vehicle 100 includes several sensors 104 configured to generate a map of the passenger compartment 102. Each sensor 104 may include one or more electronic devices configured to generate image and depth information pertaining to the sensor’s field of view. For example, each sensor 104 may include two or more cameras, including color cameras, infrared cameras, or others. Each sensor 104 may be configured to generate an image with corresponding depth information. Depth information may be generated using structured light techniques, time of flight techniques, and others. In the some embodiments, the sensors 104 may also be configured to generate depth information using laser-based techniques.

In some embodiments, the sensors 104 are arranged to provide a thorough mapping of the vehicle’s passenger compartment 102, including all of the rows of seating. The specific position and angle of each sensor 104 will depend on the shape of the vehicle’s passenger compartment 102 and fixtures therein, such as the seats 106. For example, the front seat sensor 108 may be oriented to capture a suitable image of the front seating area, but will have limited visibility for the rear seating area due to shadowing created by the front seats. Accordingly, the vehicle 100 can also include a rear seat sensor 110 positioned to capture images of the rear seating area. Additional sensors can be deployed for each additional seating area. Additionally, if the vehicle has a cargo area, a sensor may also be deployed to capture images of the cargo area.

In some embodiments, the vehicle 100 can include an additional forward-facing rear sensor 112, which may be useful for capturing images of the rear seating area that would otherwise be shadowed. For example, FIG. 1 shows a rear-facing child safety seat in the rear seating area. In such cases, a single rear camera may not have visibility of a child that may be in the child safety seat. The forward-facing rear seat sensor 112 would have that visibility and would be able to provide additional mapping information that might otherwise be missed.

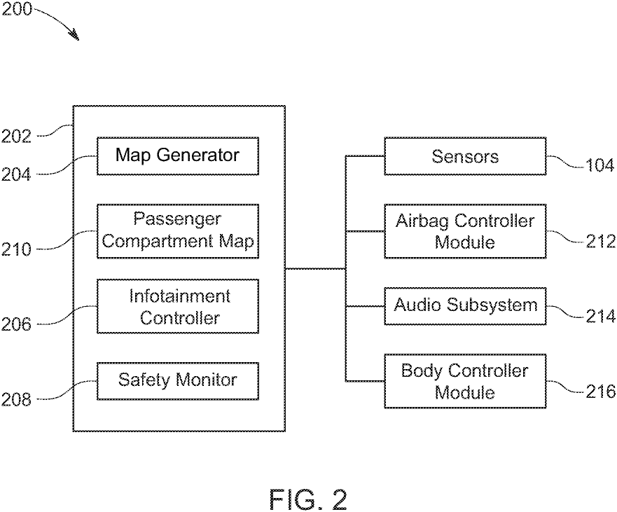

The particular embodiment shown in FIG. 1 is shown as one possible example of a system of sensors disposed in a vehicle. It will be appreciated that other configurations are also possible depending on the specific design of the vehicle’s passenger compartment and the desired level of coverage. The mapping of the passenger compartment enables the implementation of various features, some of which are described further in relation to FIG. 2.

FIG. 2 is a block diagram of a system configured for passenger compartment mapping in accordance with embodiments. The system 200 includes a controller 202, which may implemented as processing hardware or a combination or hardware and software. For example, the controller 202 may be implemented on a microprocessor such as an Application Specific Integrated Circuit (ASIC), as software or firmware executing on a general purpose processor, and the like. The controller 202 can also include electronic memory for storing instructions and data, such as pre-programmed data and/or data collected from sensors or other subsystems in the vehicle. Additionally, the controller 202 may be a dedicated controller that is dedicated to the mapping application, or the controller 202 may be implemented as a feature of a general purpose automobile computing system such as the automobile’s infotainment head unit or other electronic module.

The controller 202 may include a map generator 204, an infotainment controller 206, and a safety monitor 208. The map generator 204 receives images and depth information from the sensors 104, which are disposed in a vehicle as described in relation to FIG. 1. Based on the information from the sensors 104, the map generator 204 generates one or more passenger compartment maps 210. The map generator 204 can generate separate passenger compartment maps 210 that correspond with each sensor 104 individually, or the map generator 204 can combine the sensor data to generate a single passenger compartment map 210. In some embodiments, the image and depth data collected from the sensors 104 may be processed using machine learning algorithms that can recognize objects from the data. The map generator 204 may generate map data corresponding to the body of each passenger of the vehicle, and can include the positions of each passengers head, arms, and legs. In this way, various vehicle subsystems can be controlled based on the positions and orientation of the passengers and their activity. The map data may also indicate the presence of additional objects within the vehicle such as an object or a pet within a passenger’s lap or on a seat.

The controller 202 may be coupled to various other electronic components of the vehicle such as an airbag controller module 212, audio subsystem 214, body controller module 216, and others. The airbag controller module 212 is an electronic control unit that controls the deployment of airbags in the event of a crash. The body controller module 216 is an electronic control unit that controls various electronic devices throughout the vehicle, such as power windows, power mirrors, door locks, interior lighting, and others. The audio subsystem 214 is configured to provide audio media throughout the vehicle and may include a radio, media players, speakers, and the like. Examples of audio media include music, audio alerts and warnings, phone communications, and others.

The passenger compartment map 210 may be received by various subsystems, including the infotainment controller 206 and the safety monitor 208. Each subsystem may use the map data to implement a variety of features related to passenger safety, comfort, entertainment. In some embodiments, the safety monitor 208 can use the map to control airbag deployment. For example, the map data may indicate that a particular passenger is seated in a manner that could make airbag deployment dangerous, in which case airbag deployment could be disabled for that particular passenger. Such passenger information would be discernable from the map data, but would likely not be discernable from a seat pressure sensor. For example, the driver may be leaning forward too close the steering wheel, a passenger may be leaning forward with her head close to the airbag, or passenger may be holding an object or a pet, for example.

The safety monitor 208 may also use the passenger compartment map 210 to determine the presence and movement of passengers in the rear seat and activate safety measures accordingly. For example, the passenger compartment map 210 may indicate that a child is laying in the back seat as opposed to sitting up straight. This information may be used to alter the deployment of rear airbags, change how a seatbelt responds in the event of a crash, or alert the driver of the potentially dangerous condition through an audio alert, for example. The presence of a small child may also cause the safety monitor to send a signal to the body controller module 216 to engage child safety locks in the rear seating area or to disable window controls in the rear seating area.

The safety monitor 208 may also be used to alert passengers about the presence of a child in a child safety seat. For example, if the passenger compartment map 210 indicates that a child is in the child safety seat, the safety monitor 208 may cause the audio subsystem 214 to issue an alert after vehicle has parked or the driver door is opened, for example.

The infotainment controller 206 may use the passenger compartment map 210 to determine how to deliver media through the audio subsystem 214. For example, the passenger compartment map 210 may be used to indicate the location of a passenger’s head, which may be used to balance the audio output from the speakers to create a more realistic surround sound effect. The infotainment controller 206 may also be used to render games or other entertainment in the rear seating area, and the passenger compartment map 210 may be used to recognize hand gestures of the passengers for controlling the media or providing input to a game, for example.

In some embodiments, vehicle subsystems may be controlled to improving passenger comfort based on the passenger compartment map 210. For example, an air vent may be directed toward a passenger and may even follow the passenger as their orientation changes. Additionally, the body controller module 216 may be controlled to improve passenger comfort by automatically adjusting the position or orientation of a seat based on the size of the passenger sitting in the seat or a passenger sitting behind the seat.

The components shown in FIG. 2 may be implemented in hardware or a combination of hardware and programming. For example, the map generator 204, infotainment controller 206, and safety monitor 208 may be implemented in logic circuitry, Application Specific Integrated Circuits (ASICs), microcontrollers, general-purpose processors processing instructions stored to a non-transitory memory device, and combinations thereof. The passenger compartment map 210 may be stored to a volatile or non-volatile memory device and may be continually updated as new real-time sensor data is available.

The example implementations described above are only a small number of the possible implementations of the passenger compartment mapping system described herein. It will be appreciated that other features and processes can be enabled through the use of the passenger compartment map 210. Additionally, the block diagram of FIG. 2 is not intended to indicate that the system 200 is to include all of the components shown in FIG. 2. Rather, the system 200 can include fewer or additional components not illustrated in FIG. 2. Furthermore, the components may be coupled to one another according to any suitable system architecture.

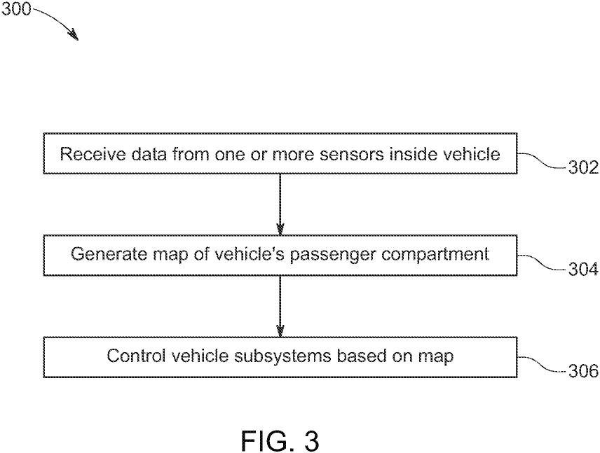

FIG. 3 is a process flow diagram summarizing an example method for controlling a vehicle based on a mapping of the passenger compartment in accordance with embodiments. The method 300 may be performed by a system such as the system 200 of FIG. 2. The method 300 is performed by logic embodied in hardware, such as logic circuitry, one or more processors configured to execute instructions stored in a non-transitory, computer-readable medium, or combinations thereof. The method may begin at block 302.

At block 302, data is received from the sensors in the vehicle. In various examples, the sensors provide depth data for a passenger compartment of the vehicle. In some examples, the sensors provide image data which may be pixelated color data and also includes depth information corresponding to each of the pixels.

At block 304, the data received from the sensors is used to generate a map of the passenger compartment. The map may be a map of the entire passenger compartment that combines all of the available information from the sensors. The sensor data can be combined based on the known orientation and position of each of the sensors, and/or based on detecting matching image portions between images captured by different sensors, which indicate areas of overlap between the sensors’ fields of view.

The passenger compartment map includes map data, which refers to the image data and the depth data captured by the sensors and can also include higher-level data that can be generated from the image and depth data. Such higher level data can be generated using machine learning or other pattern recognition algorithms, such as face detection algorithms, gesture detection algorithms and others. The higher-level map data may indicate a number of passengers in the vehicle, their locations in the vehicle, the position and orientation of their bodies, head, and limbs, an estimated age, size, or weight of particular passengers, hand gestures, and others. As used herein, the term “passenger” refers to any person within the passenger compartment including the driver.

At block 306, one or more vehicle subsystems are controlled based on the passenger compartment map. Control of the vehicle subsystems may include control of the audio subsystems, climate control, door locks and windows, the infotainment system, a rear-seat entertainment system, a safety system such as the airbag controller, and others. Control of the vehicle subsystems may be based on the positions of passengers in the vehicle, the orientation of each passenger (e.g., the positions of their head or limbs), the estimated age of a passenger, detected hand gestures, and others. The vehicle subsystems can be controlled to provide enhanced safety, comfort, or entertainment features, for example. As one example, a claimant control air vent may be adjusted based on positions and orientations of passengers indicated by the passenger compartment map. As another example, one or more door locks or rear windows may be disabled based on an estimated age of the passenger indicated by the passenger compartment map.

The method 300 should not be interpreted as meaning that the blocks are necessarily performed in the order shown. Furthermore, fewer or greater actions can be included in the method 300 depending on the design considerations of a particular implementation.

While the invention may be susceptible to various modifications and alternative forms, specific embodiments have been shown by way of example. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A vehicle with a passenger compartment mapping system, comprising:
one or more sensors to capture sensor data comprising depth data for a passenger compartment of the vehicle; and
one or more processors to:
generate a passenger compartment map from the sensor data; and
control one or more subsystems of the vehicle based on the passenger compartment map.

2. The vehicle of claim 1, wherein the one or more processors are to execute a machine learning algorithm to detect objects within sensor data and add the detected objects to the passenger compartment map.

3. The vehicle of claim 1, wherein to generate the passenger compartment map comprises to detect passenger positions and orientations from the sensor data.

4. The vehicle of claim 1, wherein to control one or more subsystems of the vehicle comprises to disable an airbag based on a passenger position and orientation indicated by the passenger compartment map.

5. The vehicle of claim 1, wherein to control one or more subsystems of the vehicle comprises to disable door locks or rear windows based on an estimate age of a passenger indicated by the passenger compartment map.

6. The vehicle of claim 1, wherein to control one or more subsystems of the vehicle comprises to adjust audio based on a position of a passenger’s head indicated by the passenger compartment map.

7. The vehicle of claim 1, wherein to control one or more subsystems of the vehicle comprises to adjust a climate control air vent based on positions and orientations of passengers indicated by the passenger compartment map.

8. The vehicle of claim 1, wherein:
to generate the passenger compartment map comprises to detect a hand gesture from the sensor data; and
to control one or more subsystems of the vehicle comprises to control a rear-seat entertainment subsystem based on the detected hand gesture.

9. The vehicle of claim 1, wherein the one or more sensors comprise at least one forward-facing sensor configured to capture images of a rear seating area.

10. The vehicle of claim 1, wherein to control one or more subsystems of the vehicle comprises to generate an alert indicating a presence of a child in a rear-facing child seat as indicated by the passenger compartment map.

11. A method of operating a vehicle, comprising:
capturing sensor data from one or more sensors disposed in a vehicle, wherein the sensor data comprises depth data for a passenger compartment of the vehicle;
generating a passenger compartment map from the sensor data, wherein the passenger compartment map comprises the depth data, and detected passenger positions and orientations; and
controlling one or more subsystems of the vehicle based on the passenger compartment map.

12. The method of claim 11, wherein controlling one or more subsystems of the vehicle comprises disabling an airbag based on detecting that a passenger position or orientation indicated by the passenger compartment map could result in unsafe deployment of the airbag.

13. The method of claim 11, wherein generating the passenger compartment map comprises detecting a hand gesture from the sensor data.

14. The method of claim 11, controlling the one or more subsystems of the vehicle comprises controlling a rear-seat entertainment subsystem based on the passenger compartment map.

15. The method of claim 11, wherein the one or more sensors comprise at least one forward-facing sensor configured to capture images of a rear seating area, and controlling one or more subsystems of the vehicle comprises generating an alert indicating a presence of a child in a rear-facing child seat as indicated by a portion of the passenger compartment map captured by the forward-facing sensor.

16. A system for mapping a passenger compartment mapping of a vehicle, comprising:
one or more sensors to capture sensor data comprising depth data for a passenger compartment of the vehicle; and
one or more processors to:
generate a passenger compartment map from the sensor data; and
control one or more subsystems of the vehicle based on the passenger compartment map.

17. The system of claim 16, wherein the one or more processors are to execute a pattern recognition algorithm to detect passengers within sensor data and add a position and orientation of each of the passengers to the passenger compartment map.

18. The system of claim 16, wherein the one or more sensors comprise at least one sensor for each row of seating, at least one forward-facing sensor, and at least one rear-facing sensor.

19. The system of claim 16, wherein to control one or more subsystems of the vehicle comprises to disable an airbag based on a passenger position and orientation indicated by the passenger compartment map.

20. The system of claim 16, wherein to control one or more subsystems of the vehicle comprises to generate an alert indicating a presence of a child in a rear-facing child seat as indicated by the passenger compartment map.
